(19) United States
(12) Patent Application Publication
(10) Pub. No.: US 2022/0046932 A1
(43) Pub. Date: Feb. 17, 2022

(54) Apparatus for Mixing Powdery Baking Ingredients with Water

(71) Applicant: DIOSNA Dierks & Söhne GmbH, Osnabrück (DE)

(72) Inventor: Stefan Bensmann, Osnabrück (DE)

(21) Appl. No.: 17/274,451

(22) PCT Filed: Aug. 26, 2019
(86) PCT No.: PCT/EP2019/072709

§ 371 Date: Mar. 9, 2021

(30) Foreign Application Priority Data
Sep. 11, 2018 (DE) 10 2018 122 132.0

(51) Int. Cl. A21C 1/14; B01F 3/12; B01F 5/02; B01F 5/20; B01F 15/00

(52) U.S. Cl. CPC A21C 1/1435; B01F 3/1228; B01F 5/0262; B01F 2215/0011; B01F 5/205; B01F 15/00961; B01F 5/0268

(57) ABSTRACT

The invention relates to an apparatus (2) for mixing powdery baking ingredients with water. The apparatus (2) comprises a mixing chamber (4) which is inclined at a gradient and is preferably vertical, which has in an upper head region (6) at least one opening (8) for powdery baking ingredients falling into the mixing chamber (4) and in which there is arranged at least one nozzle (10) from which water (12) is ejected at a pressure of at least 30 bar from at least one nozzle opening (14). The nozzle opening (14) is directed at a mechanical obstruction (16) within the mixing chamber (4). Water (12) spraying out of the nozzle opening (14), together with the supplied baking ingredients, impacts the obstruction (16) in an impact region (20). Below the mixing chamber (4) there is arranged a container (24) which is provided with a cover (22) and which is connected, in a dough-conveying manner, to a discharge opening (26) of the mixing chamber (4). The apparatus has a suction device (32) for baking ingredient dust from the container (24), which has a suction opening (34) on the container (24), an inlet opening (36) into the mixing chamber (4) and a recycling duct (38) that connects the suction opening (34) to the inlet opening (36). Thus, the suction opening (34) is arranged in the head region (40) of the container (24) and the inlet opening (36) is arranged above the impact region (20) in the mixing chamber (4).

The invention concerns an apparatus for mixing powdery baking ingredients with water. The apparatus comprises a preferably vertical mixing chamber inclined to a downward slope and comprising in an upper head region at least one opening for powdery baking ingredients that are falling into the mixing chamber. In addition, at least one nozzle is arranged in the mixing chamber and water is forced from it at a pressure of at least 30 bar through at least one nozzle opening. The nozzle opening is directed in this context toward a mechanical obstacle inside the mixing chamber. Water spraying out of the nozzle opening impacts together with the added baking ingredients on the obstacle in an impact region. By impacting on an obstacle, the baking ingredients are mixed with the water, on the one hand; at the same time, the water is however also worked into the baking ingredients by kneading movements. The kneading movements are realized also by impacting on the mechanical obstacle in the impact region.

Below the mixing chamber, a container provided with a cover is arranged which is connected in a dough-conveying manner to a discharge opening of the mixing chamber. Dough that is falling through the discharge opening of the mixing chamber but also excess water as well as baking ingredients not yet mixed with water are guided therethrough into the interior of the container. Due to the high pressure in the interior of the nozzle, the water in the interior of the nozzle is sprayed at a high velocity out of the nozzle opening. A kind of high-pressure jet is produced. This high-pressure jet entrains surrounding air in the direction toward discharge opening of the mixing chamber so that a high build-up of baking ingredient dust is generated in the container below the mixing chamber. In addition, due to the high pressure of the water, a lot of air is sucked into the mixing chamber that is guided then into the container below the mixing chamber and must be discharged again from there. Such an apparatus is disclosed, for example, in DE 20 2004 018 807 U1.

In case that the mixture of air and baking ingredient dust flowing into the container below the mixing chamber is discharged through openings inside the container, the baking dust passes to the exterior into the space surrounding the apparatus and collects there undesirably on surfaces in the environment. In order to prevent this, in front of the openings to the exterior filter bags can be mounted in the container through which the air escapes but which retain the baking dust. The filters must be frequently exchanged however. In addition, in the head space of the container above the dough that has already been mixed to larger chunks, small and already moist dough particles are also swirled about which quickly clog the filter. The air introduction into the container amounts to approximately 500 to 1,000 m³/hrs. in conventional apparatus.

It is object of the invention to provide an apparatus of the aforementioned kind in which the aforementioned problems are reduced.

The invention is solved by an apparatus according to the preamble of claim 1 which, in addition, comprises the features of the characterizing portion of claim 1.

Further particulars and details of the invention are contained in the dependent claims.

According to the invention, the apparatus comprises a suction device for baking ingredient dust from the container. The suction device comprises in this context a suction opening at the container, an inlet opening into the mixing chamber, and a recycling duct that connects the suction opening and the inlet opening to each other. The suction opening is arranged in the head region of the container and the inlet opening above the impact region in the mixing chamber. Due to the accelerated water in the interior of the mixing chamber, air is entrained from the recycling duct through the inlet opening into the mixing chamber. In turn, the entrained air sucks in air that is enriched with baking ingredient dust from the head region of the container, located above the dough present at the bottom of the container, which, in turn, passes through the suction opening into the recycling duct and from there through the inlet opening into the mixing chamber. In the mixing chamber, the baking ingredient dust entrained from the recycling duct is mixed with the water from the nozzle and processed to dough. As a result, a higher proportion of the powdery baking ingredients are processed with water to dough compared to the prior art. In addition, hardly any air is discharged from the container into a region outside of the apparatus because the excess air which is present within the container is returned again together with the baking ingredient dust that is present therein through the recycling duct to the mixing chamber. Due to the suction device according to the invention, it is not necessary to provide air discharge openings in the container which are provided with dust filters. For this reason, an exchange of such filters is also obsolete. In addition, the suction device works without its own motor for air movement because the vacuum that is already generated due to the water jet from the nozzle is used in a targeted fashion.

In this context, the interior of the mixing chamber is delimited, on the one hand, by walls and the opening in the head region of the mixing chamber, on the other hand, by backed-up baking ingredients that flow into the mixing chamber. In this way, as a result of the high flow velocity of the water exiting from the nozzle, a vacuum is generated in the interior of the chamber and causes the flow of the mixture of baking ingredient dust and air from the suction opening to the inlet opening.

In an advantageous embodiment of the invention, the mechanical obstacle inside the mixing chamber is formed by an inner wall of the mixing chamber. The nozzle opening is thus oriented toward the inner wall of the mixing chamber. In an alternative embodiment thereto, the obstacle is formed by a water jet from an additional nozzle from which the water is forced from at least one additional nozzle opening at a pressure of also at least 30 bar. In this context, the nozzle opening of the additional nozzle is oriented such that the water jet from the first nozzle and the water jet from the additional nozzle cross each other in an impact region. Both water jets form therefore in operation a mechanical obstacle for the respective other water jet and, at the same time, the water from each of the nozzles is worked into the baking ingredients.

In both cases, the water is sprayed, particularly preferred, in a cone shape from the nozzles and impacts therefore as a kind of ring on the mechanical obstacle in the impact region. The baking ingredients which are introduced into the mixing chamber are therefore guided inside the mixing chamber preferably also in a ring shape along the wall of the mixing chamber, which is preferably cylinder-shaped, by means of guiding elements and agitating members in the direction toward the impact region so that the baking ingredients ideally meet the added water not until the impact region. In this way, adherence of the dough inside the mixing chamber at the wall of the mixing chamber is prevented.

In a preferred embodiment of the invention, each one of the one or more nozzles each comprises a nozzle body with a bottom end at which the nozzle opening is arranged and with a top end positioned opposite thereto. The inlet opening in this context is preferably arranged below the top end of the nozzle body in the mixing chamber. Due to this configuration, it is achieved that the powdery baking ingredients that flow through the inlet opening into the interior of the mixing chamber as well as small dough shreds do not deposit on top of the nozzle body and thereby keep from being further processed in the container below the mixing chamber.

The suction opening is advantageously arranged in the cover of the container. Due to this positioning, baking ingredient dust from the head region of the container can be sucked away particularly effectively into the recycling duct. In a particularly preferred embodiment of the invention, the recycling duct comprises at least two bends each of at least 70 degrees, in particular of 80 to 110 degrees. At the outer radius of these bends, baking ingredient dust particles as well as small dough particles can deposit and be removed therefrom in a targeted fashion.

In a particularly preferred embodiment of the invention, the bends are formed by elbows which are each separately openable and/or arranged in the recycling duct so as to be reversibly removable. Due to the separately openable elbows, particles that have deposited in the elbows and have not dropped back into the container can be easily removed. Due to the reversible removability of the elbows, they can be removed completely for cleaning and subsequently installed again in the recycling duct.

Advantageously, the recycling duct is designed such that the cross section of the recycling duct tapers from the suction opening to the inlet opening. Due to the tapering of the cross section of the recycling duct, the mixture of air and baking ingredient dust is increasingly accelerated so that the separation effect within the recycling duct is also increased.

In another particularly preferred embodiment of the invention, the recycling duct comprises a supply socket into the recycling duct that can be regulated by a valve. Via the supply socket, gases, liquids or even smaller particles in the interior of the recycling duct that are to be entrained by the air baking ingredient dust can be added in a targeted fashion. Adding is realized in this context by the valve belonging to the apparatus.

Advantageously, the apparatus comprises at least one pump that pumps the water through a water supply line into the one or more nozzles and generates in the interior of the nozzle a water pressure of 30 to 1,000 bar, preferably of 50 to 200 bar, and in particular of 80 to 150 bar. In this context, each nozzle can have its own water supply line and its own pump or one pump supplies a plurality of nozzles via a plurality of water supply lines.

In a preferred embodiment of the invention, the apparatus comprises at least one supply member that is configured to supply baking ingredients from a storage directly or indirectly to the opening in the head region of the mixing chamber. Such a supply member can be formed, for example, by a worm conveyor that is arranged in a pipe and by means of which particulate baking ingredients, for example, flour, are supplied to the opening in the head region of the mixing chamber. In this context, the supply member closes, together with the baking ingredient located in the interior of the supply member, the interior of the apparatus relative to the space outside of the apparatus in operation. In this way, a vacuum can be built up in the interior of the mixing chamber as a result of the air entrained by the water jet from the nozzle. The vacuum can be compensated then only by air which is flowing via the inlet opening into the mixing chamber and not through the opening in the head region of the mixing chamber itself.

In a particularly preferred embodiment of the invention, the opening in the head region of the mixing chamber is provided with a merging arrangement into which at least one outlet of a supply member opens. In the merging arrangement, additionally an air supply opening is arranged that is regulatable by means of a valve and through which the air can be sucked in a metered manner into the merging arrangement and therethrough into the mixing chamber. Via the air supply opening, the vacuum in the interior of the mixing chamber and thereby the velocity at which the air is conveyed from the suction opening in the head region of the container to the inlet opening in the mixing chamber can be regulated with the aid of the valve belonging to the apparatus. In addition, through this control of the vacuum by means of the valve, particulate baking ingredients flowing into the mixing chamber and thereby also their quantity can be regulated. In this way, the use of a differential metering scale for individual baking ingredients may be obsolete. In place of the differential metering scale, the quantity of the baking ingredients flowing into the interior of the mixing chamber is regulated by means of the vacuum in the interior of the mixing chamber that is adjustable by the valve of the air supply opening.

Further details and advantages of the invention result from the dependent claims as well as from the schematically illustrated embodiment described in the following; it is shown in:

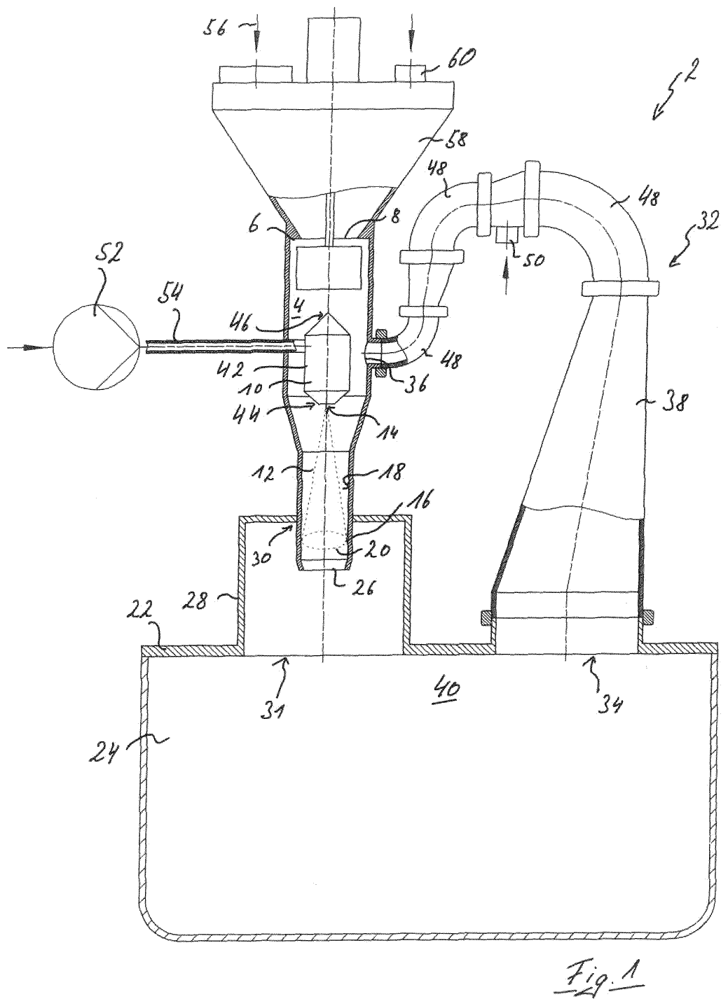

FIG. 1 an apparatus according to the invention in a partially sectioned side illustration.

The features of the invention explained in the following can be subject matter of invention also individually or in other combinations than described and illustrated. In the following, elements of the invention that are acting in the same way are provided with a uniform reference number, provided that this is expedient.

FIG. 1 shows an apparatus 2 according to the invention for mixing powdery baking ingredients with water with a vertical mixing chamber in the embodiment which comprises in an upper head region 6 at least one opening 8 for powdery baking ingredients falling into the mixing chamber 4. In the meaning of the invention, the upper head region 6 is understood as the region of the mixing chamber 4 which is positioned in vertical direction above functional elements possibly arranged in the mixing chamber 4.

In the mixing chamber 4, at least one nozzle 10 is arranged from which water, illustrated in the invention as dotted lines 12, is pressed through at least one nozzle opening 14 under a pressure of at least 30 bar. The nozzle opening 14 in this context is directed toward a mechanical obstacle 16 inside the mixing chamber 4. This mechanical obstacle 16 is formed in the embodiment by the inner wall 18 of the mixing chamber 4. Water 12 which is sprayed from the nozzle opening 14 impinges together with the supplied baking ingredients onto the obstacle 16 in an impact region 20. As a result of the impact, the water mixes with the baking ingredients and, at the same time, the water is kneaded into the baking ingredients so that a dough is produced.

Below the mixing chamber 4, a container 24 provided with a cover 22 is arranged which is connected in a dough-conveying manner with a discharge opening 26 of the mixing chamber 4. In the embodiment, the connection is realized by means of a bell-shaped cover 28 that is arranged between container cover 22 and mixing chamber 4 and into which a lower end of the mixing chamber 4 projects through an opening 30 of the bell-shaped cover 28 in the upper region, wherein the bell-shaped cover 28 in addition is placed about an opening 31 in the container cover 22. The path to the exterior of the apparatus 2 is blocked in this way for powdery baking ingredients.

The apparatus 2 comprises a suction device 32 for baking ingredient dust from the container 24. The suction device 32 comprises a suction opening 34 at the container 24, an inlet opening 36 into the mixing chamber 4, and a recycling duct 38 which connects the suction opening 34 and the inlet opening 36 to each other. The suction opening 34 is arranged in this context in the head region 40 of the container 24 and the inlet opening 36 above the impact region 20 in the mixing chamber 4. The head region 40 of the container 24 in the meaning of the invention is understood as the region above the dough positioned on the bottom of the container 24 and thus the head space located thereabove inside the container 24.

The nozzle 10 in the interior of the mixing chamber 4 comprises a nozzle body 42 with a bottom end 44 at which the nozzle opening 14 is arranged and an oppositely positioned top end 46. The inlet opening 36 is arranged in the mixing chamber 4 below the top end 46 of the nozzle body. Baking ingredient dust exiting from the inlet opening 36 during operation as well as small dough particles therefore do not deposit from above on nozzle body 42.

The recycling duct 38 comprises in the embodiment three bends of at least 70 degrees, respectively, in particular of 80 to 110 degrees. The bends are formed by elbows 48. The elbows 48 can be separately opened and are moreover arranged in the recycling duct 38 so as to be reversibly removable.

The cross section of the recycling duct 38 tapers from the suction opening 34 to the inlet opening 36. The tapering in this embodiment is not continuous but is realized in steps. However, the tapering can also be realized continuously. At the recycling duct 38, a supply socket 50 is arranged which can be regulated by a valve and through which further baking ingredients or gases and media influencing the baking process can be added in a targeted fashion. Metering is realized by means of the valve. The apparatus 2 comprises in addition a pump 52 that pumps the water 12 via a water line 54 into the nozzle 10 and, in the interior of the nozzle 12, builds up a water pressure of 30 to 1,000 bar, preferably of 50 to 200 bar, and particularly preferred of 80 to 150 bar. The apparatus 2 comprises at least one supply member, illustrated by the arrow 56, that is embodied to supply baking ingredients from a storage directly or indirectly to the opening 8 in the head region 6 of the mixing chamber 4. The opening 8 in the head region 6 of the mixing chamber 4 is provided with a merging arrangement 58 which is formed by a funnel in the embodiment. The outlet of the supply member 56 opens in the merging arrangement 58. In addition, in the merging arrangement 58 an air supply opening 60 is arranged which can be regulated by a valve and through which air can be sucked in a metered fashion into the merging arrangement 58 and therethrough into the mixing chamber 4.

### REFERENCE NUMBERS

2 apparatus
4 mixing chamber
6 upper head region
8 opening
10 nozzle
12 water
14 nozzle opening
16 mechanical obstacle
18 inner wall of the mixing chamber
20 impact region
22 cover
24 container
26 discharge opening
28 bell-shaped cover
30 opening of the bell-shaped cover
31 opening in the container
32 suction device
34 suction opening
36 inlet opening
38 recycling duct
40 head region of the container
42 nozzle body
44 bottom end of the nozzle body
46 top end of the nozzle body
48 elbow
50 supply socket
52 pump
54 water conduit
56 supply member
58 merging arrangement
60 air supply opening

What is claimed is:

1.-12. (canceled)

13. An apparatus for mixing powdery baking ingredients with water, the apparatus comprising:
a mixing chamber comprising an head region, the head region comprising an opening through which the powdery baking ingredients enters the mixing chamber, wherein the mixing chamber comprises a section with a downwardly inclined slope and further comprises a discharge opening opposite the head region;
a first nozzle arranged inside the mixing chamber;
the first nozzle comprising a first nozzle opening and configured to press water as a water jet at a pressure of at least 30 bar from the first nozzle opening into the mixing chamber;
the first nozzle opening directed toward a mechanical obstacle inside the mixing chamber, wherein the water jet from the first nozzle and the powdery baking ingredients impact on the obstacle in an impact region of the mixing chamber;
a container arranged below the mixing chamber and comprising a cover;
the container connected to the discharge opening of the mixing chamber;
a suction device comprising a suction opening connected to the container and an inlet opening connected to the mixing chamber;
the suction device further comprising a recycling duct connecting the suction opening and the inlet opening with each other, wherein the suction device is configured to convey baking ingredient dust from the container to the mixing chamber;
wherein the suction opening is arranged in a head region of the container and wherein the inlet opening is arranged above the impact region of the mixing chamber.

14. The apparatus according to claim 13, wherein the mechanical obstacle is formed by an inner wall of the mixing chamber.

15. The apparatus according to claim 13, further comprising a second nozzle comprising a second nozzle opening and configured to press water as a water jet at a pressure of at least 30 bar from the second nozzle opening into the mixing chamber, wherein the mechanical obstacle is formed by the water jet pressed from the second nozzle opening, wherein the second nozzle opening of the second nozzle is oriented such that the water jet from the first nozzle opening and the water jet from the second nozzle opening cross each other in the impact region.

16. The apparatus according to claim 13, wherein the first nozzle comprises a nozzle body with a bottom end and with a top end opposite the bottom end, wherein the first nozzle opening is arranged at the bottom end, and wherein the inlet opening of the suction device is arranged below the top end of the nozzle body.

17. The apparatus according to claim 13, wherein the suction opening is arranged in the cover of the container.

18. The apparatus according to claim 13, wherein the recycling duct comprises at least two bends, each bend bent at an angle at least 70 degrees.

19. The apparatus according to claim 18, wherein the angle amounts to 80 degrees to 110 degrees.

20. The apparatus according to claim 18, wherein the at least two bends are formed by elbows, wherein the elbows are separately openable and arranged so as to be reversibly removable in the recycling duct.

20. The apparatus according to claim 18, wherein the at least two bends are formed by elbows, wherein the elbows are separately openable.

21. The apparatus according to claim 18, wherein the at least two bends are formed by elbows, wherein the elbows are arranged so as to be reversibly removable in the recycling duct.

23. The apparatus according to claim 13, wherein a cross section of the recycling duct tapers in a direction from the suction opening toward the inlet opening.

24. The apparatus according to claim 13, further comprising a supply socket connected to the recycling duct and configured to be regulated by a valve.

25. The apparatus according to claim 13, further comprising a pump configured to pump water through a water supply line into the first nozzle and to generate in an interior of the first nozzle a water pressure of 30 bar to 1,000 bar.

26. The apparatus according to claim 25, wherein the water pressure amounts to 50 to 200 bar.

27. The apparatus according to claim 26, wherein the water pressure amounts to 80 bar to 150 bar.

28. The apparatus according to claim 13, further comprising at least one supply member configured to supply the powdery baking ingredients from a storage to the opening in the head region of the mixing chamber.

29. The apparatus according to claim 28, further comprising a merging arrangement arranged at the opening in the head region of the mixing chamber, wherein at least one outlet of the at least one supply member opens into the merging arrangement.

30. The apparatus according to claim 29, further comprising an air supply opening configured to be regulated by a valve and arranged in the merging arrangement, wherein the air supply opening is configured to suck a metered amount of air into the merging arrangement and into the mixing chamber.
